(19) United States
(12) Patent Application Publication
(10) Pub. No.: US 2014/0230177 A1
(43) Pub. Date: Aug. 21, 2014

(54) WIPER BLADE FOR THE CLEANING OF VEHICLE WINDSCREENS

(71) Applicant: Valeo Systèmes d'Essuyage, Le Mesnil Saint Denis (FR)

(72) Inventors: Michael Schaeuble, Vaihingen/Enz (DE); Bruno Egner-Walter, Heilbronn (DE)

(73) Assignee: VALEO SYSTÈMES D'ESSUYAGE, Le Mesnil Saint Denis (FR)

(21) Appl. No.: 14/347,059

(22) PCT Filed: Sep. 24, 2012
(86) PCT No.: PCT/EP2012/068757

§ 371 Date: Mar. 25, 2014

(30) Foreign Application Priority Data
Sep. 28, 2011 (DE) 10 2011 054 021.0

(51) Int. Cl. B60S 1/38

(52) U.S. Cl. CPC B60S 1/3879; B60S 1/3856
USPC 15/250.32

(57) ABSTRACT

The invention relates to a wiper blade (10) for cleaning vehicle windscreens with a wiper blade body (15) exhibiting a wiper rubber (16) which is connectable to a wiper arm via a wiper blade adapter (11), wherein the wiper rubber (16) exhibits a receiving groove (19, 20) for a spring strip (17, 18) on each of its two longitudinal sides, said spring strip projecting from the receiving groove (19, 20), wherein the two spring strips (17, 18) are disposed in the wiper blade adapter (11) at a defined parallel distance from each other by means of at least one holding element (30) in each case. It is provided according to the invention that the two spring strips (17, 18) are received in holding elements (30), which are U-shaped, in the wiper blade adapter (11) wherein the lateral legs (37, 38) of the holding elements (30) directly embrace the spring strips (17, 18) on their top side and underside, and that the holding elements (30) are received in mounts (29), which are U-shaped in cross-section, of the wiper blade adapter (11).

### STATE OF THE ART

The invention relates to a wiper blade for cleaning vehicle windscreens according to the preamble of claim 1.

A wiper blade of this kind is known from DE 10 2008 042 839 A1. In the case of the known wiper blade, spring strips are arranged on the two longitudinal sides of the wiper rubber, which serve to stiffen the wiper rubber and produce an even contact pressure of the wiper rubber on the vehicle windscreen. The two spring strips exhibit apertures arranged spaced from one another in the longitudinal direction, with which pin-shaped projections of a basic element connected to the actual wiper blade adapter engage, the basic element moreover exhibiting strip-shaped feet, which are bendable towards the underside of the spring strips and thereby fix the spring strips in the basic element. The basic element is in turn connected to the wiper blade adapter, as already mentioned, which is used to fasten the wiper blade to a wiper arm. The fact that the spring strips are positioned relative to the basic element via the extensions of the basic elements acting as holding elements means it is possible for the space between the two spring strips perpendicular to their longitudinal direction to be adjusted to one another, such that the wiper rubber can be replaced by removing said wiper rubber from the spring strips, as the spring strips do not apply contact pressure to the groove base of the receiving grooves of the wiper rubber.

### DISCLOSURE OF THE INVENTION

Starting with the presented state of the art, the problem addressed by the invention is that of developing a wiper blade for the cleaning of windscreens according to the preamble of claim 1, such that the basic element used in the state of the art, which is relatively elaborately designed to fasten the spring strips, is replaced with a structurally simple element and that the wiper blade adapter overall can be produced relatively simply and cost-effectively. This problem is solved according to the invention by a wiper blade for the cleaning of vehicle windscreens with the features of claim 1, in that the two spring strips are received in holding elements, which are U-shaped in cross-section, in the wiper blade adapter, wherein the lateral legs of the holding elements directly embrace the spring strips on their top side and underside, and that the holding elements are received in mounts, which are U-shaped in cross-section, of the wiper blade adapter.

Advantageous embodiments of the wiper blade according to the invention for the cleaning of vehicle windscreens are specified in the dependent claims. All combinations of at least two of the features disclosed in the claims, description and/or figures fall within the framework of the invention.

In order to keep the number of holding elements as small as possible, it is particularly preferably provided that only a single holding element is assigned to each spring strip.

Particularly good guidance and fixing of the spring strips in the wiper blade adapter is achieved if the holding element has a length which corresponds to the length of the U-shaped mount in the wiper blade adapter. Moreover, the U-shaped mount in the wiper blade adapter can thereby be particularly easily made.

To fasten the holding element in the wiper blade adapter, it is proposed in a preferred embodiment that at least one of the lateral legs of the holding element engages by at least one deformation section with a recess of the wiper blade adapter in a form-fitting and clamp-fitting manner and thereby fixes or positions the holding element relative to the wiper blade adapter.

In a particularly preferred embodiment of the deformation section, it is provided that the at least one deformation section of the lateral leg of the holding element is bent around in the direction of the recess. It is thereby particularly possible when designing the holding element from sheet steel for the holding element to be snapped together with the wiper blade adapter.

Moreover, it is particularly preferably provided for the fastening of the spring strips in the holding element for at least one of the lateral legs of the holding element to engage by at least one deformation section with a further recess of the spring strip in a form-fitting or clamp-fitting manner and thereby fix or position the spring strip relative to the holding element.

In order to facilitate a particularly secure fastening both of the spring strip to the holding element and also of the holding element to the wiper blade adapter, it is furthermore preferably provided that two deformation sections are provided in each holding element, which are arranged spaced apart from each other in the longitudinal direction of the holding element.

The recesses in the wiper blade adapter and in the spring strip are particularly easy to produce in manufacturing terms if the recesses are each formed as an aperture.

In order to keep the assembly forces relatively low when introducing the holding element into the mount of the wiper blade adapter, it is further suggested that the recesses should be arranged staggered with respect to each other in one direction transversely to the longitudinal extension of the spring strip. As a result of this, the deformation sections move one after the other into the recesses of the wiper blade adapter, which, moreover, can be determined by touch and therefore makes a controlled assembly process possible.

In a quite particularly preferred embodiment, it is provided that the wiper blade adapter is designed as a metallic cast part or as an extruded plastic moulded part and that the holding elements are made of a harder material compared with the wiper blade adapter.

Further advantages, features and details of the invention emerge from the following description of preferred exemplary embodiments and also with the help of the drawing.

In the figures:

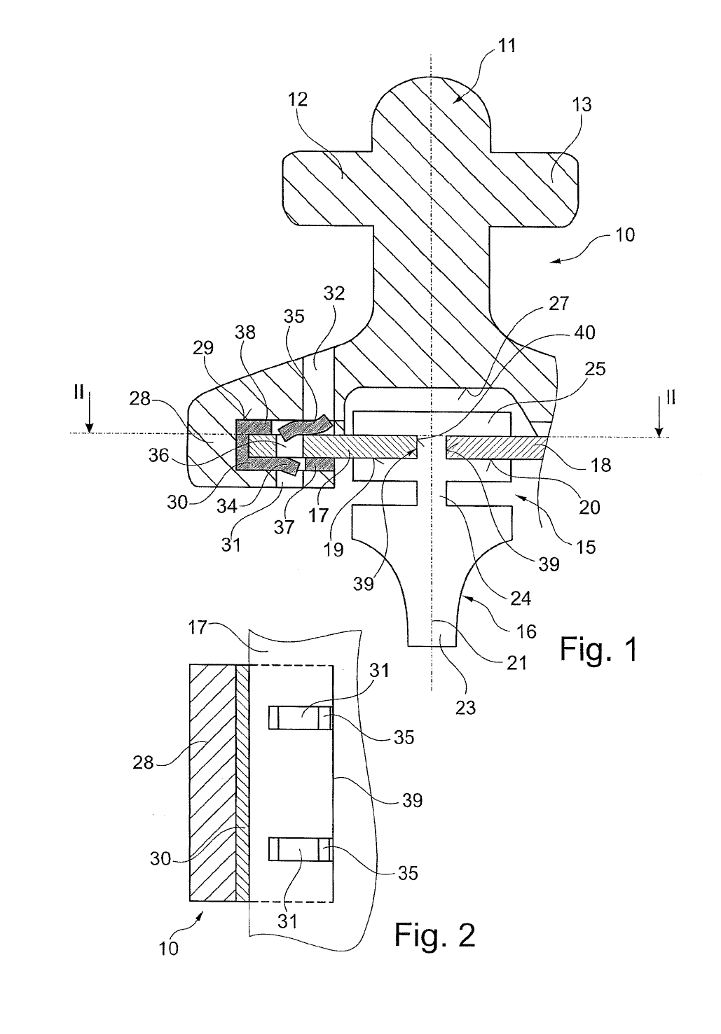

FIG. 1 shows a cross-section through a wiper blade for the cleaning of vehicle windscreens according to the invention and

FIG. 2 shows a view of plane II-II in FIG. 1.

The same components or components with the same function are provided with the same reference numbers in the figures.

In FIG. 1 a wiper blade 10 for the cleaning of vehicle windscreens according to the invention is shown in cross-section. The wiper blade 10 can be interchangeably fastened to a wiper arm, which is not shown, of a windscreen wiper system. A wiper blade adapter 11, which is designed either as a metal cast part or as a plastic injection moulded part is used for this. The fastening of the wiper blade 10 or of the wiper blade adapter 11 to the wiper arm is achieved by way of example and not therefore restrictively via two bearing pins 12, 13 arranged laterally to the wiper blade adapter 11 in a manner known per se, wherein the bearing pins 12, 13 are simultaneously used for the pivot-mounting of the wiper blade 10 to the wiper arm.

In addition to the wiper blade adapter 11, the wiper blade 10 comprises a wiper blade body 15 in elongated form. The wiper blade body 15 essentially comprises a strip-shaped wiper rubber 16 extending on a plane perpendicular to the plane of projection of FIG. 1 and also two spring strips 17, 18 arranged on the longitudinal sides of the wiper rubber 16 and interacting with the wiper rubber 16. The spring strips 17, 18 formed as stamped parts made of sheet steel are strip-shaped in design and project with a partial section into receiving grooves 19, 20 formed in the longitudinal direction of the wiper rubber 16 which are U-shaped in cross-section. The spring strips 17, 18 are used firstly to stiffen the wiper rubber 16 on a plane perpendicular to the symmetrical axis 21 and secondly to produce a uniform contact pressure wherever possible of the wiper rubber 16 on the vehicle's windscreen, which is not shown but is customarily curved, for which purpose the spring strips 17, 18 are usually slightly curved in design. The two opposite end sections of the wiper blade body 15 (not shown), i.e. of the wiper rubber 16 and of its spring strips 17, 18, are provided with end caps which can be slipped onto and dismantled from the wiper blade body 15. The wiper rubber 16 produced by extrusion has a wiper lip 23 on the side facing the vehicle windscreen, which is connected via a tilting link 24 to a base section 25 of the wiper rubber 16 which is H-shaped in cross-section.

The wiper blade adapter 11 forms a recess 27 on the side facing the wiper blade body 15 which is open in the direction of the wiper blade body 15. The wiper blade body 15, at least with its two spring strips 17, 18 and the base section 25, are received in the recess 27. Symmetrically to the symmetrical axis 21, the wiper blade adapter 11 further exhibits two laterally arranged fastening arms 28, only one fastening arm 28 being identifiable in FIG. 1. In alignment with the spring strips 17, 18 of the wiper blade body 15, the two fastening arms 28 exhibit mounts 29, which are U-shaped in cross-section and run over the entire length of the fastening arms 28 perpendicular to the plane of projection in FIG. 1. The mounts 29 are used to (directly) receive the spring strips 17, 18. For this purpose it is provided according to the invention that in each of the mounts 29 for the corresponding spring strip 17, 18 a holding element 30 which is likewise U-shaped in cross-section can be disposed.

The holding element 30 is preferably formed as a stamped-bent part and is made of metal, particularly sheet metal. Essential to this is that the material of the holding element 30 preferably exhibits a greater hardness than the material of the wiper blade adapter 11. It can be seen particularly from FIG. 2 that the holding element 30 exhibits a length which corresponds to the length of the fastening arms 28.

Above and below the spring strips 17, 18, mounts in the form of apertures 31, 32 are formed in each of the securing arms 28. As can be seen from FIG. 1, the two apertures 31, 32 are arranged staggered with respect to each other in relation to the symmetrical axis 21 and, as can be seen particularly from FIG. 2, the fastening arm 28 exhibits two apertures 31, 32 spaced apart from each other in the longitudinal direction of the fastening arm 28. The apertures 31, 32 preferably have a rectangular cross-section.

In alignment with the apertures 31, 32, deformation sections 34, 35 are formed in the holding element 30, which are used for the positionally precise fixing of the holding element 30 in the mount 29 of the securing arm 28. In this case, the one deformation section 34, which is arranged on the underside of the spring strip 17, only interacts with the fastening arm 28 or with the aperture 31 thereof, while the other deformation section 35, which is arranged on the top side of the spring strip 17, interacts with both the aperture 32 in the fastening arm 28 and also with a recess formed as an aperture 36 in the spring strip 17, through which the spring strip 17, 18 in each case is fixed relative to the holding element 30. The two deformation sections 34, 35 are preferably formed beforehand, i.e. prior to assembly of the spring strip 17, 18 or prior to assembly of the holding element 30 in the fastening arm 28, in that the corresponding areas of the deformation sections 34, 35 are (mechanically) bent out of their original plane aligned with the lateral legs 37, 38 of the holding element 30. What is significant here is that the deformation sections 34, 35 can be elastically deflected from their bent over position.

Assembly of the wiper blade 10 may take place in various ways with a possible method of assembly described below simply by way of example and not therefore with any restrictive force. The two holding elements 30 are first introduced into the corresponding securing arms 28 or the mounts 29 thereof, whereupon the deformation sections 34, 35 engage with the apertures 31, 32 in the fastening arm 28 and thereby fix and position the holding element 30 within the fastening arm 38. The respective spring strip 17, 18 can then be introduced into the holding element 30 assigned to it, wherein the deformation sections 35 engage with the apertures 36 of the respective spring strip 17, 18 and therefore also fix and position the spring strip 17, 18 relative to the holding element 30 and the wiper blade adapter 11.

What is essential here is for the location or positioning of the spring strip 17, 18 in the wiper blade adapter 11 to be such that the end faces 39 of the spring strips 17, 18 facing the receiving grooves 19, 20 abut the groove base 40 of the receiving groove 19, 20 essentially without any contact pressure or that a certain gap is formed between the end faces 39 and the groove base 40, which is not shown in FIG. 1. In order to replace a wiper rubber 16, it is thereby possible to remove the (worn) wiper rubber 16 from the spring strips 17, 18 once the corresponding end cap of the wiper blade body 15 on the end face has been dismantled and then to thread or insert a new wiper rubber 16 again between the spring strips 17, 18. In this case, the spring strips 17, 18 remain on the wiper blade adapter 11.

The wiper blade 10 described thus far may be transformed or modified in a plurality of ways without deviating from the basic idea underlying the invention. This involves the positioning or fixing of the spring strips 17, 18 in the wiper blade adapter 11, such that the spring strips 17, 18 abut the groove base 40 of the wiper rubber 16 with their front faces 39 at least in a virtually force-free manner, as a result of which a wiper rubber 16 can be simply removed from or reintroduced into the wiper blade 10.

### Reference List

10 Wiper blade
11 Wiper blade adapter
12, 13 Bearing pin
15 Wiper blade body
16 Wiper rubber
17, 18 Spring strip
19, 20 Receiving groove
21 Symmetrical axis
23 Wiper lip
24 Tilting link
25 Base section
27 Recess
28 Fastening arm
29 Mount
30 Holding element
31, 32 Aperture
34, 35 Deformation section
36 Aperture
37, 38 Lateral leg
39 Front face
40 Groove base

1. A wiper blade for the cleaning of vehicle windscreens, comprising:
a wiper blade body, having a wiper rubber, the wiper blade body being connected with a wiper arm via a wiper blade adapter,
wherein the wiper rubber at its two longitudinal sides has respectively a receiving groove for a spring strip, which projects laterally out from the receiving groove,
wherein the two spring strips are arranged in the wiper blade adapter at a defined parallel distance from each other by means respectively of at least one holding element,
wherein the two spring strips are received in holding elements, which are U-shaped in cross-section, in the wiper blade adapter, wherein lateral legs of the holding elements directly embrace the spring strips on their upper side and lower side, and wherein the holding elements are received in mounts, which are U-shaped in cross-section, of the wiper blade adapter.

2. The wiper blade according to claim 1, wherein that a single holding element is associated with each spring strip.

3. The wiper blade according to claim 1, wherein the holding element has a length which corresponds to the length of the U-shaped mount in the wiper blade adapter.

4. The wiper blade according to claim 1, wherein at least one of the lateral legs of the holding element engages by at least one deformation section into a recess of the wiper blade adapter in a form-fitting or clamp-fitting manner, and thereby fixes the holding element to the wiper blade adapter.

5. The wiper blade according to claim 4, wherein the at least one deformation section of the lateral leg of the holding element is bent around in the direction of the recess.

6. The wiper blade according to claim 1, wherein at least one of the lateral legs of the holding element engages by at least one deformation section into an additional recess of the spring strip in a form-fitting or clamp-fitting manner, and thereby fixes the spring strip to the holding element.

7. The wiper blade according to claim 4, wherein respectively two deformation sections are provided in each holding element, which are arranged spaced apart from each other in the longitudinal direction of the holding element.

8. The wiper blade according to claim 4, wherein the recesses are constructed as an aperture in the wiper blade adapter and in the spring strip.

9. The wiper blade according to claim 8, wherein the recesses are arranged staggered with respect to each other in a direction transversely to the longitudinal extension of the spring strip.

10. The wiper blade according to claim 1, wherein the wiper blade adapter is constructed as a metallic cast part or as a plastic injection moulded part, and wherein the holding elements consist of sheet steel material which is harder than a material of the wiper blade.
